(19) United States
(12) Patent Application Publication
(10) Pub. No.: US 2004/0057410 A1
(43) Pub. Date: Mar. 25, 2004

(54) Information transfer between and end user and a radio network, involving the user's wlan-or corresponding identifier and a sub-base station server

(76) Inventors: Miska Juho Topias Kaipiainen, Vaasa (FI); Sakari Tuomas Johannes Salin, Vaasa (FI); Marko Kalervo Nieminen, Vaasa (FI)

Correspondence Address: James A Hudak, Suite #304, 29425 Chagrin Boulevard, Cleveland, OH, 44122, US

(21) Appl. No.: 10/296,604

(22) PCT Filed: May 22, 2001
(86) PCT No.: PCT/FI01/00497

(30) Foreign Application Priority Data
May 26, 2000 (FI) 20001272

(51) Int. Cl. H04Q 7/00; H04Q 7/24

(52) U.S. Cl. 370/338; 370/328

(57) ABSTRACT

A method and equipment for transferring information between base stations and between a base station and an end user using a wireless network solution. The base station is divided into sectors, in which case each sector of a base section is separately a base station. In this case, each sector has its own transmitter/receiver and server or cache memory, at least. Many tasks that have loaded the whole network earlier, such as user identification, are now transferred to the server of the sub-base station. The invention is especially meant to be used with the assistance of WLAN-cards, in which case the identification is performed through both the number of the WLAN-card and the user name and password.

The present invention relates to a method and equipment for transferring information, and more exactly to a method and equipment that are based on using radio links in a new way.

Wireless systems have begun to become more and more common in information technology. In telephone connections the wireless system has grown much faster than the system based on an electric cable or optical fibre cable.

The spreading of portable computers has brought a greater need for wireless data transfer connections than before. Different kinds of monitoring devices, cameras, fire alarms etc. increase the need for a wireless network even further. Offices become more flexible, if no fixed work places exist, and houses and homes can be connected to the network at an increasingly economical price and simple method with wireless LAN (Local Area Network) systems.

The Wireless (WLAN=Wireless Local Area Network) system is standardized internationally and different counties also have their own statutes in addition to the standard. The IEEE 802.11-standard and its versions /a and /b are used as the standard. The statutes mention, for example, which transmission powers are allowed in each country. Typically the USA allows 1000 mW power, Europe (EIRP) 100 mW power and Japan 10 mW/MHz. Furthermore, the frequency ranges have been standardized and the channel numbers to be used with them have been agreed upon (DSSS; Direct Sequency Spread Spectrum transferring technique).

Channels exist in total from number 1-13. The channels are separated from each other by a 5 MHz frequency difference. Besides this, there exists, depending n the country, 20-80 so-called “jump channels” of small difference, with a 1 MHz frequency difference. This 1 MHz frequency difference, which gives more channels, is however slow and it easily has disturbances. (FHSS=Frequency Hopping Spread Spectrum). The problem of the system has been the small, allowed transmission power. With this, the authorities aim to protect humans and animals from excessively large radiomagnetic radiations. Also the appearance of disturbances for similar devices functioning in the same frequency range can be decreased with low power.

An attempt has been made to improve audibility in high frequency ranges by aiming the transmission in a narrow sector in the direction of the recipient. For example, parabolic mirrors, cylinder-like so-called Yagi-antennas etc. are used as auxiliary instruments. In many cases, however, the antenna is directed in all directions; in other words an antenna that radiates to a circular space is needed, so that customers receive the message everywhere in the area of the transmission range (Omni-antennas).

The wireless radio-network system is implemented in many places so that a so-called point-to-point connection exists between the customer and the base station, which functions, but does not allow the customer to move without breaking the connection.

Different kinds of applications of radio-link systems are described in the following patent publications.

U.S. Pat. No. 4,128,740 describes how a directional antenna-system can be accomplished, in which each sub-antenna of a certain direction has its own transmission receiver frequency, i.e. channel input.

U.S. Pat. No. 6,046,701 describes a sector antenna, in which a dielectric lens, focusing the transmission, is used in each direction of the transmission-sector. In this a spherical surface is used as a dielectric lens, which from its inside, transmitted from one side with a cable, it aims all of the signals in the same direction. In this way, an effectiv point-to-point antenna is accomplished.

U.S. Pat. No. 6,016,123 describes a sectored antenna system in which each antenna-group aimed in the same direction has its own transmitter-receiver and in which at least two directional antennas always belong in the above-m ntioned antenna-group.

U.S. Pat. No. 6,038,459 presents a solution such that a transmitter and receiver-amplifier are situated in an antenna mast in the immediate vicinity of the antenna elements, so that the attenuation between the antenna and the transmitter/receiver can be minimized. The problem in this solution is that the maintenance of the transmitter-receiver electronics is difficult, when it is situated at the top of the antenna mast.

U.S. Pat. No. 6,023,458 presents a radio network solution, in which the central unit is attached with cables to sub-units (“Cell Centers”) and these sub-units transmit the final customer connection with wirelessly polarized directional antennas of several sectors. The maximum transmission distance between a sub-unit and a customer can be 870 m and in the frequency of 30 GHz a transmission rate f 900 Mb/s is obtained.

U.S. Pat. No. 6,009,096 presents how video, data and sound can be transferred with the same system, which is based on a main station and a message sent from it to sub-stations with Omni-radiation antennas, which further send the customer signals with the ATM system (Asynchronous Transfer Mode), and that all of the signal types from different sources are collected at the main station onto a so-called “Sonet Ring” and all the different signal forms are sent from the same point.

U.S. Pat. No. 6,058,105 presents how a fast virtual channel is accomplished using many antennas in the transmission and many antennas in the reception for the same transmission of signals, so that a virtual channel is formed, always through one real channel, from part of the transmitting signal, and these part-chann l signals are joined again in the receiver end into a fast, perfect signal flow. According to the invention, total transfer rate of 20 Mb/s on a 30 kHz channel width and an S/N-ratio (Signal to Noise ratio) of 20 dB can be s nt along 170 virtual channels.

U.S. Pat. No. 6,052,599 presents a system for a network communication system, in which many inputs and receptions of the same frequency are joined into the transmission cell of the directional antenna, so that they are located on different sides of the directional plane antenna and so that the reception cable is connected to a different part of the same antenna than the transmission cable. A computer separates the received signals from each other according to different modulation. In this way, more connected phone calls and other transmitted data transfer can be accomplished with certain frequency ranges and their limited amount (channels). In this solution, the slowness of the computer in separating signals modulated in different ways produces a problem, in which case the whole rate of transmission/reception is limited.

Some basic solutions were discussed above, with which a wireless network for a larger area can be formed, however, keeping the number of sub-stations small however.

The commercial brochure about the network system “Breezecom Wireless Access solutions”, relates further how the sub-stations are organized in connection with the regional central station and with other networks with a cable connection. A cable connection also is between the regional central station and the sub-stations. The Breezecom-system also uses FHSS (Frequency Hopping Spread Spectrum).

In the quite recently published patents listed above, there is nothing especially mentioned about scrambling the network (encryption) and identifying the customer. Radio transmitter-receiver networks, which then serve the private consumer, have been formed using these antenna solutions and corresponding solutions, of which several exist besides the previous examples.

The purpose of this invention is to accomplish a new way f thinking in forming a regional network. The purpose is to accomplish a fast data-transfer connection and minimal network loading in such situations in which it is possible to avoid l ading the whole network. In addition, the purpose is to accomplish a method and equipment by which the customer has the possibility to move freely within th range of the network, while maintaining the connection between the customer and the network, independent of the location.

The above-mentioned and other advantages and positive features of this invention have been accomplished with a method and equipment, the characteristic features of which have been stated in the accompanying Claims.

The accompanying drawings present some of the basic features of the invention in simplified pictures. Thus:

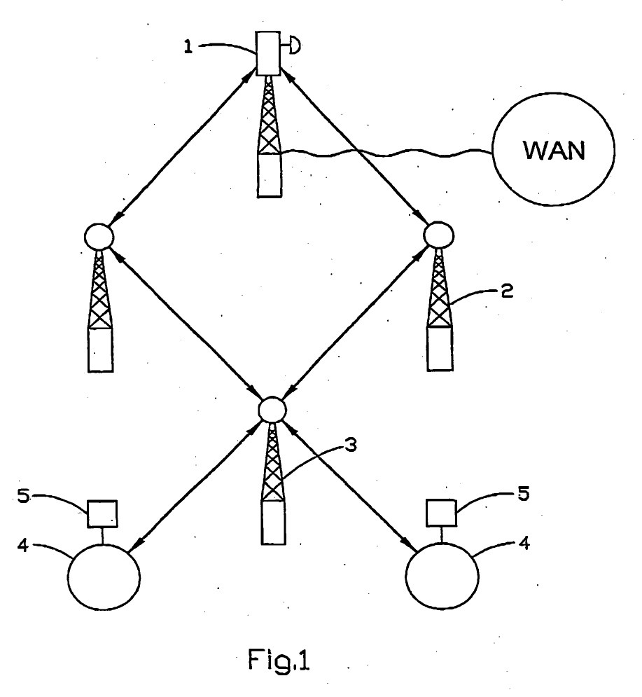

FIG. 1 presents one very simplified diagram in principle of the invention;

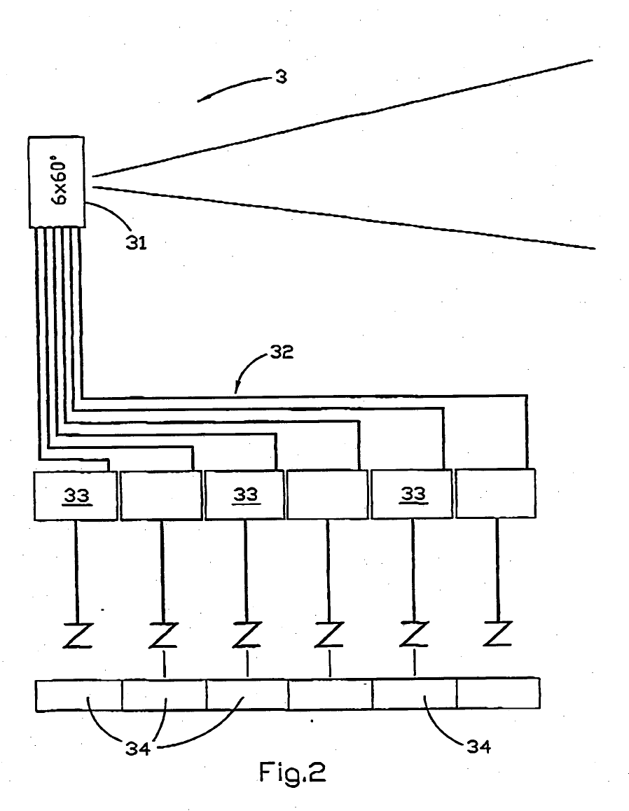

FIG. 2 presents the operating principle of each antenna unit related to the invention; and

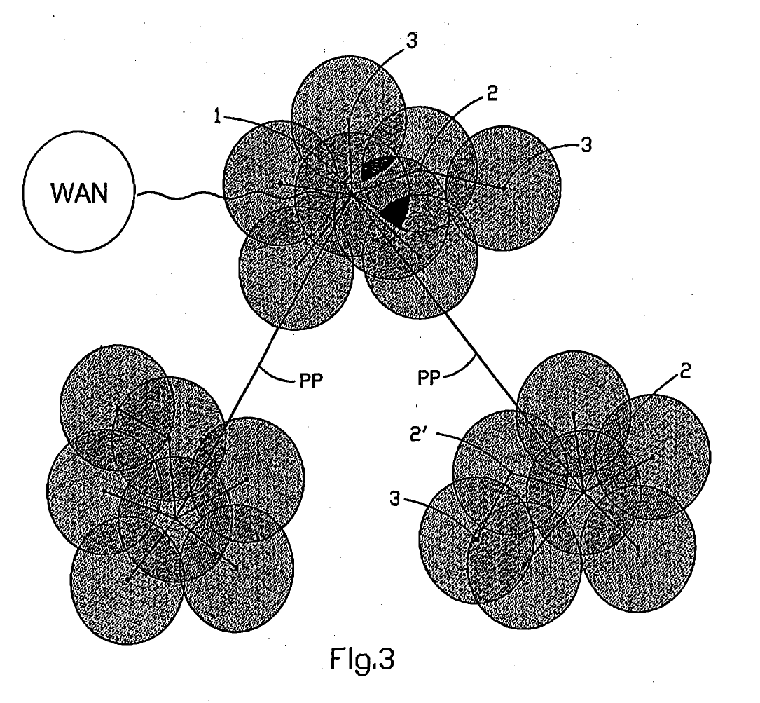

FIG. 3, for its part presents one illustrative picture of the structure of the network.

The invention is based on the sectoring principle, in which the connection from sector to sector is arranged automatically, when the customer's message at th border of the “visibility” area of the previous sector starts to weaken.

According to this invention, it is possible to achieve a radio network system that is high-power, radiates all around and operates in sectors, and whose characteristic feature is that the transmission power of each sector is the highest possible and that each sector is simultaneously its own, complete base station, antenna-receiver-transmitter and local server and/or cache memory.

Thus, according to this invention, each customer gets the highest possible transmission-receiv r power and th rest of the network is not loaded unnecessarily, as th sector's own server handles the identification and in many cases already possesses the requested s rvice (proxy). A large transmission/noise-ratio ensures a high communicati n speed with a low symbol-error probability.

In the solution according to this invention a main base station and a regional sub-base station are used, along with the actual sub-base station, which only interacts with the customer. Each base station may also be in the use of the customer, when he/she moves in the area covered by the network. In order that the distance between the base stations can be maintained as large as possible, there is a sector antenna-system between each main base station and regional base station, in which each antenna of a sector is fed by its own signal transmitter, so that the allowed transmission power is only at the end of the signal cable.

The principle mentioned above is clarified in FIGS. 1, 2 and 3. In FIG. 1, the main base station is indicated with reference number 1, possible intermediate base stations with reference number 2 and the sub-base stations, which perform the actual communication with the customer 4, with reference number 3. Reference number 5 for its part indicates the directional antenna used by the customer 4, by means of which the communication takes place wirelessly. Th letter combination WAN=Wide Area Network.

FIG. 2 presents a closer-up structure of any base station whatsoever according to the invention. For example, it can be assumed that the sub-base station 3 of the base station network presented in FIG. 1 is in question, although any other base station whatsoever may also be in question. Antenna 31 is divided into sectors such, for example, into six 60-degree sectors. For example, the signal entering and leaving each sector passes along cabling 32 to the base stations 33, the number of which is the same as of the sectors, i.e. in this case 6 pieces. The signal moves from base station 33 to servers 34. Each sector and thus each server has its own IP-address or other suitable identifier information. Thus, ach sector forms an independent, functioning whole.

FIG. 3 presents, in the case of three regi nal network-parts, how the base station network can be arranged. Networking can happen also regionally with a regional main base station, which however in this case is indicated with the sub-base station symbol 2 ka and after that through a single- or multiple-stepped base station line, as is indicated with th number series 2, 2′ and 3 at th lower right-hand corner of the diagram. The letter combination pp is intended for the so-called point-to-point connection.

The sub-base station has a server (proxy-server), which identifies the user in tw ways. The first identification is the number of the users (WLAN) card, the MAC-code (standard), and the other is the user name and password. When the us r attempts to join the network the base station's own server checks the MAC-code of the WLAN-card and the reported password and user name, and then the local server (proxy server) opens the gate to the network.

The encryption of the communication of the entire network is easy to arrange, when already the first server of the sub-base station can handle the encryption. Proceeding in this way, the main servers of the network, as well as the network itself, is not at all loaded with the identification of the user and similar routines, in which case a great deal of capacity is freed for actual information transfer. The local server (proxy-server) also records a lot of files, which are requested frequently, and can load these straight to the customer. Due to this the load of the network is further lessened. This local sever can also be a cache memory or a combination of a server and cache memory. The local server merely checks if the date of the requested file and the one in its memory are the same. If the date is the same, the whole file is fed to the customer straight from the local server.

Strongly directive antennas are between the main base station and regional base station; the local base station can use either an OMNI-radiating antenna or further sector antennas which are channeled so that the channels of adjacent or overlapping sectors are separated from each other by 5 channels, thus minimizing the reciprocal disturbance of the channels.

This radio-link network serves information transfer and oth r forms of digital communication very well. The transfer rate can be ven 11 Mb/s when using a 2.4 GHz direct sequ nce-spread spectrum transmissi n mod . The final receivers served by the network and the final transmitters are normal antennas equipped with all-round radiating antennas or advantageously also directional antennas. When directional antennas are used, each antenna sector has its own local server with its own IP-number or corresponding identifier. The local server is also able to route the transfer of messages quickly, so that this operation, too, is relieved from the main base station server.

Through the base station sector nearest to the customer it is also possible to prioritize different sorts of messages without the whole network being loaded with this prioritization. The local base station's own server also enables a phone call based on a name only, without loading the entire network even then. The server sends a list, if plenty of similar names exist, and the customer can choose the “correct” name by way of his phone.

Also such priorities, with which a customer can obtain guaranteed traffic by naturally paying a higher fee for this type of prioritization, can be programmed onto the local server. With this local base station and server combination it is especially advantageous to monitor points at which there is a possibility of sounding an alarm or monitoring or other of that type of activity. Because this loads the network only when something happens, this type of customer order can be delivered very advantageously. Naturally, also other pricing principles can be applied, like regional pricing or pricing according to a rush in connections or some other factor.

The combination of a local base station and server makes the penetration into the network by hacking extremely difficult, because “firewalls” exist between each link-connection.

The network solution developed now is especially well suitable for Internet- and corresponding usage, in which every user device uses a WLAN-card.

The develop d solution according to the invention deviates essentially from other corresponding solutions in that it uses sector antennas, in which each sector has its own transmitter-receiver and local s rver with its wn IP-number. Furthermore, the signal cable and signal transmitter are arranged so that the allowed maximum signal power is in the antenna, measured one wavelength away from, for example, the antenna's transmitter-dipole, always the same or slightly smaller than the allowed power. The whole antenna-system can thus be fed a power of N×Max. A further feature of the solution is that the system recognizes the user in two ways; it recognizes the device separately from the so-called MAC-number of the WLAN-card and the person using the device by the password and other identification information fed by the user, which has been programmed to the server of the nearest sub-base station when a customer connection agreement has been made. If the customer is elsewhere in the network area than within his so-called “own” base station sector, the network searches automatically for the identification information and opens a gate for the connection.

According to the now-presented invention it is thus possible to give the same base station in a network more than one IP-number, in which case each sector of the base station is served by its own local server (proxy-server) with its own IP-number. In this way, only a limited area traffic is created between the base station and sub-base station and thus the speed of the traffic can be ensured. For example, the sub-base station “sees” only the local server with IP-number 10.11.41-10.11.42 and the number of the directional antenna attached to it, even though the whole base station may have a numerous group of IP-numbers and corresponding local servers, for example, 10.11.2.1, 10.11.3.1 10.11.4.1 etc. Th system can also decrease the communication inside the network and thus increase the capacity of the system. For example, if some WWW-page is already in the memory of the local server, the server will check through the main base station only the updating of the WWW-page and if no update has been made it transfers the information directly to the customer, without having to load the whole file through the network to the customer.

According to Shannon's equation the transmission capacity of a transfer channel depends on the following factors:

Transmission capacity R=B lg₂(1+S/N), in which

B=bandwidth (Hz), S=signal power and N=noise power. S/N is normally 20 dB.

When the noise is almost always nearly constant, a high transmission power guarantees the largest possible transmission capacity of the transmission per direction band and simultaneously it guarantees the smallest possible digital symbol-error probability, which is obtained clearly under the value 10⁻⁸.

As mentioned, in the method of this invention the difference between channels is 5 MHz and the signal power in the output is the allowed 100 mW and the bandwidth e.g. 2.4 GHz in which case the disturbance noise is under the 5 dB class over the basic noise.

In relation to the method and equipment, the signal transmitters and receivers are, as is well known, the devices that can be most easily damaged in a network of this kind. When some sector transmitter or sector receiver is damaged and switched off, the connection can always be achieved through an adjacent sector or through some other sector by moving around through another regional base station. If the main base station server or local server recognizes large power changes in one specific route or if some transmitter/receiver is damaged, it will investigate the optimal routing during the whole radio traffic. The main base station and sub-base stations can advantageously be in connection with each other through point-to-point antennas.

The radio network is arranged to function only with such receivers which are fitted with a WLAN-card or corresponding identifier. With this, a normal radiophone can naturally also be easily connected to the network. This solution is especially advantageous in such societies in which it is difficult to build wire-connections and difficult to get electric current. If the amount of electric current needed by a base station with six sectors is about 300 W, the needed amount of current is obtained from an area of 2-4 m² of solar panel or by using a fuel cell or windmill or advantageously by their combination.

The wireless link-system can be linked advantageously with so-called point-to-point, fully directional links to another corresponding link-system in a neighboring city or remote city districts even a long distance away (about 10-15 km).

After making an agreement, a suitable calibrating program is deliv red to th computer of the customer, with which the custom r can install his own WLAN antenna in such a place and position that the maximum signal strength is obtainable.

In the customer's own rooms the method can be advantageously implemented using, for example, the help of the Blue-tooth system to monitor the rooms in relation to fire, trespassing or water damage etc. or it can be used to remote-control the devices of the rooms. Furthermore, this remote control can be arranged so that the nearest sub-unit of the server of the network functions as a “janitor” of the rooms, controlling heating, ventilation etc. as a function of the outdoor temperature and the “human load” of the rooms. In other words, the network can replace the local intelligence and control of a smart house.

When, again, these alarm and monitoring tasks are brought under the care of a local server, they do not load the actual network almost at all. Most advantageously the mentioned technique is built so that a cache memory or the local base station server (proxy) has a cache memory logic only in one place, which serves several IP-numbers of the base station at the same time. This does not exclude that each server of a base station sector could have a cache memory logic.

When a base station cluster has plenty of transmitters and receivers near each other, it is advantageous, in order to lower disturbance radiation, to close each one into its own Faraday cage; i.e. the cases are situated inside a common case.

Alarms can be prioritized always, even if the network is completely full. The pricing of the services can be arranged according to this system regionally, so that a fixed monthly fee is determined, for example, according to how broadly the network has been agreed to be used. The lowest pricing could be for local alarms and the broadest pricing could involve such devices, which make use of a mobile radi signal, such as p rtable computers and WAP-phones. If th network is desired to be used in broad-band s rvices, like video conferences held through the Internet, th heavy loading of the signal flow is taken into account in the pricing.

1. A method for transferring information between an end user and a radio network, comprising the user's WLAN-identifier or other data terminal equipment giving a usable identifier and an antenna and sub-base station connected to it, the field of the transmitter/receiver of which is divided into sectors, in which case the sub-base station is linked in a suitable way with possible other base stations and through the main station to the network, in which case a transmitter and receiver have been arranged in each directional segment at least in a sub-base station interacting with a customer and if desired also in other base stations, characterized in that a local server situated in each sector segment or at least a cache memory/cache memory logic is used for information transfer.

2. A method according to claim 1, characterized in that at least the traffic between an end user and a sub-base station is arranged to function wirelessly using directional antennas.

3. A method according to claim 1, characterized in that the traffic between a sub-base station and possible regional base stations, and between the aforesaid and the main base station is also arranged to function wirelessly using directional antennas.

4. A method according to claim 1, characterized in that each sector of each base station is fed with the maximum allowed output power.

5. A method according to claim 1, characterized in that the sector channels f the base stations are separated from each other by a 5 channel channel-difference in both the horizontal and vertical directions.

6. A method according to any of the above claims, characterized in that each equipm nt of a sector segment of a base station is given its own IP-number or corresponding type of identifier.

7. A method according to any of the abov claims, characterized in that in a case of malfunction of ordinary information transfer, the information passag is routed again automatically, for example, from the antenna sector segment of the same antenna directed in the same direction, but situated in a different layer, or from an antenna sector segment directed in a different direction through another sub-base station or main base station.

8. A method according to any of the above claims, characterized in that the server of a sub-base station is used to take care of the alarm and monitoring tasks of a customer.

9. A method according to any of the above claims, characterized in that customers are given, according to their need, rights belonging to different prioritization categories.

10. A method according to any of the above claims, characterized in that a customer is always identified by the server of the sub-base station nearest to th customer.

11. A method according to claim 10, characterized in that a customer is identified by the WLAN-card number he is using, as well as by a user name and password..

12. Equipment for transferring information between an end user and a radio network comprising a terminal device (4) which gives the user's WLAN-identifier and an antenna (5) and sub-base station (3) attached to it, the transmitter/receiver field of which is divided into sectors, in which case the sub-base station is linked, in a suitable way, to possible other base stations (2) and through the main station (1) to the network, in which case a transmitter and a receiver is in at least each sector segment (s) of a sub-base station (3) interacting with a customer, characterized in that each sector segment also comprises a local server or at least a cache memory/cache memory logic.

13. Equipment according to claim 12, haracterized in that each base station( 1, 2, 3) comprises the transmission/receiver equipment and directional antenna system divided into the desired sector s gments, in ord r to arrange reciprocal communication.

14. Equipment according to claim 12, characterized in that each equipment-part of a sector segment of a base station has its own IP-number.

15. Equipment according to claim 12, characterized in that it comprises also the so-called Blue Tooth-type or corresponding wireless close-range information transfer equipment within the rooms of a customer, in order to perform different kinds of monitoring, control and alarm tasks as controlled by the network.

16. Equipment according to claim 12, characterized in that at least some of the base stations are equipped with their own energy source independent of the electric power network, such as a solar cell, fuel cell or windmill.

17. Equipment according to claim 12, characterized in that it also comprises a device or program to set the maximum allowed transmission power for each sector of the base station.
